(19) United States
(12) Patent Application Publication
(10) Pub. No.: US 2026/0021523 A1
(43) Pub. Date: Jan. 22, 2026

(54) Roller Having Heating Device, Printing Unit, Embossing Unit, and/or Rolling Mill Having Such a Roller and Method for Converting a Heating Device of a Roller

(71) Applicant: Matthews International GmbH, Vreden (DE)

(72) Inventors: Rene WOLTERS, Stadtlohn (DE); Maik HOPER, Aachen (DE)

(21) Appl. No.: 19/272,585

(22) Filed: Jul. 17, 2025

(30) Foreign Application Priority Data
Jul. 19, 2024 (DE) 10 2024 102 650.0

(51) Int. Cl. B21B 27/08; B29C 59/04; B41F 3/52

(52) U.S. Cl. CPC B21B 27/08; B29C 59/04; B41F 3/52; B21B 2027/086

(57) ABSTRACT

The invention relates to a roller for a, comprising at least one heating device for heating the lateral surface of the roller, wherein the heating device comprises at least one channel arranged within the roller, wherein at least one electrical heating element is arranged within the channel, and at least one, preferably at least partially fluid and/or pourable, heat conducting element is arranged in at least one intermediate space between an outer surface of the heating element and an inner wall of the channel; a rolling mill, embossing unit, and/or printing unit, in particular for producing elements of an electrical storage device, and a method for converting a heating device of a roller.

### CROSS-REFERENCE TO RELATED APPLICATIONS

The present application claims priority to German Patent Application No. 10 2024 102 650.0 filed Jul. 19, 2024, which is incorporated herein by reference in its entirety.

### DESCRIPTION

The present invention relates to a roller having a heating device, in particular a roller for a rolling mill, embossing unit and/or printing unit, comprising at least one heating device for heating the lateral surface of the roller, wherein the heating device comprises at least one channel arranged within the roller, as well as a printing unit, embossing unit, and/or rolling mill having such a roller and a method for converting a heating device of a roller.

Rollers, in particular anilox rollers, and printing units, embossing units, and/or rolling mills, in particular anilox and/or flexographic printing units, having rollers are increasingly used in particular in production processes of electrical storage devices such as batteries, accumulators, capacitors, electrolyzers, and the like.

Thus, these printing units, embossing units, and/or rolling mills enable continuous processing in comparison to the sequential or serial processing of individual elements. This increases the throughput and the production speed. Processing speeds of 300 m/min and more are desired. Components of the electrical storage device, which can be produced from windable carrier materials such as foils, are processed by means of such rolling mills, in particular coated, cured, and/or formed.

For many processing steps it is advantageous, if not even required, for the rollers to be heated. Rolling mills or multi-roll systems are known from the prior art in which the rolls are usually heated using a fluid, in particular oil, in order to achieve the necessary ambient conditions for processing the carrier material, such as an operating temperature for film production. Such fluid heaters result in considerable effort in handling, connection, maintenance, and replacement of the rollers. In addition, the maximum temperature of the rollers is limited by the oil used, in particular to a maximum temperature of 300° C. to 360° C.

Controlling the temperature of rollers using an electrical system is also known. These offer the advantage that higher temperatures of up to 750° C. can be generated on the surface or lateral surface of the roller. Multiple heating elements can also be actuated separately in order to be able to set and regulate the desired heating profiles over the course of the roller. This is also possible using multi-part heating elements that have multiple heating zones or heating segments which can be operated or actuated separately. Such heating profiles are not possible due to the uniform temperature of a fluid in fluid-heated rollers.

However, in order to achieve high operating temperatures in such rollers having electrical heating elements, in particular higher temperatures than are possible using fluid heating devices, extremely high demands have to be placed on the production precision of the heating elements and the channels for accommodating the heating elements in the roller. A press fit having ultra-low tolerances has to be achieved. The reason for this is that any gap between the outer wall of the heating element and the inner wall of the channel results in the inclusion of air that acts as insulation. In these areas, heat transfer from the heating element to the roller is impeded. This can result in local overheating and overstressing of the heating element, resulting in failures and defects of the heating element. Furthermore, this results in hot spots and cold spots on the lateral surface of the roller, which results in inconsistent processing of the carrier material fed to the roller.

However, due to the higher operating temperatures possible by way of an electrical heater, it is often desirable to convert existing fluid-heated rollers to an electrical heater.

Due to the required exact matching of the geometry of the existing channels to the geometry of the electrical heating elements, very complex post-processing of the entire roller is necessary. However, such subsequent processing (for example, enlarging the existing bores) of the fluid-heated rollers for the installation of an electric heater results in a significant influence on the properties of the roller, in particular with regard to concentricity, balancing, and the accompanying running properties. Without further extensive post-processing of the roller, this would result in a loss of the existing precision, for example in undesired vibrations of the roller.

In addition, retrofitting a heating cartridge in a central bore of a roller is not sufficient. Such an arrangement of electrical heating elements does allow, on the one hand, a reduction in post-processing but, on the other hand, does not allow sufficient heating of the roller surface to the desired temperatures. The heating power of electric heating elements or heating cartridges is not sufficient for this. Furthermore, because of the sluggishness of the heating due to the material mass of the roller to be heated, it is not possible to regulate the temperature of the roller surface within the necessary narrow temperature limits. Significant temperature fluctuations occur on the surface.

Therefore, fluid-heated rollers have only been used up to this point in facilities in which an oil temperature control is provided.

Furthermore, due to the special requirements for leak-tight fluid channels for the heating fluid, such as oil, electrically temperature-controlled rollers can only be used in rolling mills designed for electrical temperature control. A transfer or conversion of the rolls from one rolling mill to another is therefore currently not possible.

It is therefore an object of the present invention to provide a roller which enables heating of the roller surface to the temperatures required for processing carrier materials for the production of elements of electrical storage devices, while at the same time being fail-safe. Furthermore, the possibility is to be provided being able to convert existing fluid-heated rollers to electrical heating without having to perform a fundamental reworking of the roller, in particular to ensure synchronous running of the roller.

This object is achieved by a roller for a rolling mill, embossing unit, and/or printing unit, comprising at least one heating device for heating the lateral surface of the roller, wherein the heating device comprises at least one channel arranged within the roller, wherein at least one electrical heating element is arranged within the channel, and at least one, preferably at least partially fluid and/or pourable, heat conducting element is arranged in at least one intermediate space between an outer surface of the heating element and an inner wall of the channel.

It is proposed here that the channel is designed as a fluid channel, wherein the fluid channel is suitable for having at least one heating fluid flow through it, in particular before the heating element is arranged in the fluid channel or after the heating element is removed from the fluid channel.

It is preferred here that the heating fluid comprises oil, water, and/or a glycol-containing liquid.

It is also proposed that the heat conducting element, optionally furthermore, comprises at least one clamping element, in particular a conical clamping element, which at least in some areas can be brought into contact, in particular mechanical and/or heat conducting contact, with the lateral surface of the heating element and the inner surface of the channel and/or forms the heat conducting element.

It is preferred that a thickness of the clamping element is changeable and/or adjustable along a normal direction of the surface of the heating element and/or a normal direction of the inner surface of the channel.

In the two above-mentioned embodiments, it is preferred that the clamping element comprises at least in some areas at least one metallic material, optionally aluminum, copper, magnesium, brass, bronze, silver, gold, and/or tungsten.

It is also proposed that the, in particular at least partially fluid and/or pourable, heat-conducting element comprises at least one filler material, optionally containing graphite, arranged at least partially in the intermediate space.

The roller can be characterized in that the graphite content in the filler material is more than 40%, preferably more than 50%, more preferably more than 60%, still more preferably more than 70%, still more preferably more than 80%, and most preferably more than 90%.

It can also be provided that the filler material is powdery at least in some areas, pasty at least in some areas, and/or highly viscous at least in some areas.

Furthermore, it is proposed that the heating element has at least two, preferably a plurality of heating zones, wherein the heating zones are arranged along a longitudinal direction of the channel and/or heating element and/or the heating zones are arranged in a circular direction of the channel and/or the heating element and/or the heating zones have different first characteristics, in particular different heating outputs and/or different heating times.

It is also preferred that at least two, preferably a plurality of heating elements are present, wherein the heating elements have different second characteristics, in particular different heating outputs and/or different heating times.

Furthermore, a roller can be characterized by at least one sensor, in particular a temperature sensor, which is inserted at least in some areas into the channel and/or is operatively connected to the channel.

Finally, it is preferred for the roller that the roller is usable in a printing unit, embossing unit, and/or rolling mill for producing elements of an electrical storage device, such as a battery, an accumulator, a capacitor, an electrolyzer, and/or a fuel cell.

Furthermore, a printing unit, embossing unit, and/or rolling mill is supplied, in particular for producing elements of an electrical storage device, such as a battery, an accumulator, a capacitor, an electrolyzer, and/or a fuel cell, comprising at least one roller according to the invention and/or described above.

A method for converting a heating device of a roller is also proposed, wherein the method comprises
providing a roller having at least one fluid channel suitable for at least one heating fluid to flow through it,
arranging at least one electrical heating element in the fluid channel, and
arranging at least one, preferably at least partially fluid and/or pourable, heat conducting element in at least one intermediate space between an outer surface of the heating element and an inner wall of the channel.

The method can be characterized in that at least one wiring of the heating element is arranged in at least one central channel, at least one inlet channel, in particular of the fluid channel, at least one outlet channel, in particular of the fluid channel, and/or at least one connecting opening, in particular of the central channel, the inlet channel, and/or the outlet channel.

Finally, it is preferred that the arrangement of the wiring comprises the prior smoothing and/or rounding of acute-angled edges present in the fluid channel, the outlet channel, the connecting opening, the central channel, and/or the inlet channel, optionally using at least one mechanical deburrer, optionally comprising at least one pipe deburrer and/or at least one conical milling cutter.

The invention is therefore based on the surprising finding that an electric heating device for a roller can be designed in such a way that heating of the surface of the roller to temperatures of up to 750° C. is made possible by arranging a heat conducting element between the electric heating element and the inner wall of a channel accommodating the electric heating element. The heat conducting element is preferably at least partially fluid and/or pourable, but does not have to be.

For example, an element can also be used as a heat conducting element, the thickness of which adapts itself, in particular mechanically, to a distance of the heating element from the inner wall when the heating element is inserted into the channel, such as a clamping element, in particular a conical clamping element.

Alternatively or additionally, the, in particular fluid and/or pourable, heat-conducting element can comprise an, optionally powdery and/or pasty, filler material. This offers the advantage that essentially any irregularities on the surface of the heating element and/or the inner surface of the channel can be compensated, thus fluctuations in the distance between the surface and the inner surface can be compensated without causing air inclusions that have an insulating effect or impair or prevent heat transfer from the heating element to the roller. Furthermore, a filler material allows materials having high thermal conductivity to be able to be used.

Graphite, for example, which has a thermal conductivity of

$$140 \frac{W}{m * K} ,$$

is a material that is both cost-effective and efficient.

The use of such a heat conducting element also enables a cost-effective and uncomplicated conversion of a fluid-heated roller to an electrically-heated roller. For example, in present fluid-heated, particularly oil-heated, rollers, peripheral bores or channels, particularly fluid channels exist, arranged outside the central axis of rotation, just below the lateral surface of the roller. The heated fluid, in particular oil, flows through these bores to heat the roller.

The invention described here now allows such fluid-heated rollers to be converted to electrical heating. In particular, no changes to the roller are necessary in this case that would prevent further fluid heating. This means that it is also possible to convert back to fluid heating.

In particular, the use of the heat conducting element makes it possible to avoid any geometric changes to the roller, such as widening the fluid channels or adding channels, which would result in warping of the roller or imbalance and thus a loss of precision.

For the conversion, electrical heating elements are introduced into the peripheral (fluid) channels and an existing distance between the inner wall of the respective channel and the respective heating element is compensated by means of the heat conducting element or arranged by displacing the air in this area. This can take place from one side of the roller but also, for example in the case of a very large barrel width, i.e. longitudinal extension, on both sides with respect to the axis of rotation of the roller. This also makes it possible to work with two or more heating elements per channel. In this case, at least one heating element is introduced in each case from opposite sides with respect to the axis of rotation of the roller. These can then be actuated separately.

The heating elements themselves can have a homogeneous temperature distribution. However, it is also possible to use heating elements having different heating zones. This allows an adapted temperature distribution to be achieved on the barrel surface or the lateral surface of the roller and any temperature fluctuations caused by the roller body to be compensated.

Additionally, thermocouples can be used in the existing channels to monitor the temperature near the barrel surface of the roller.

Further features and advantages of the invention will be apparent from the following description, in which preferred embodiments are explained based on the appended figures.

In the figures

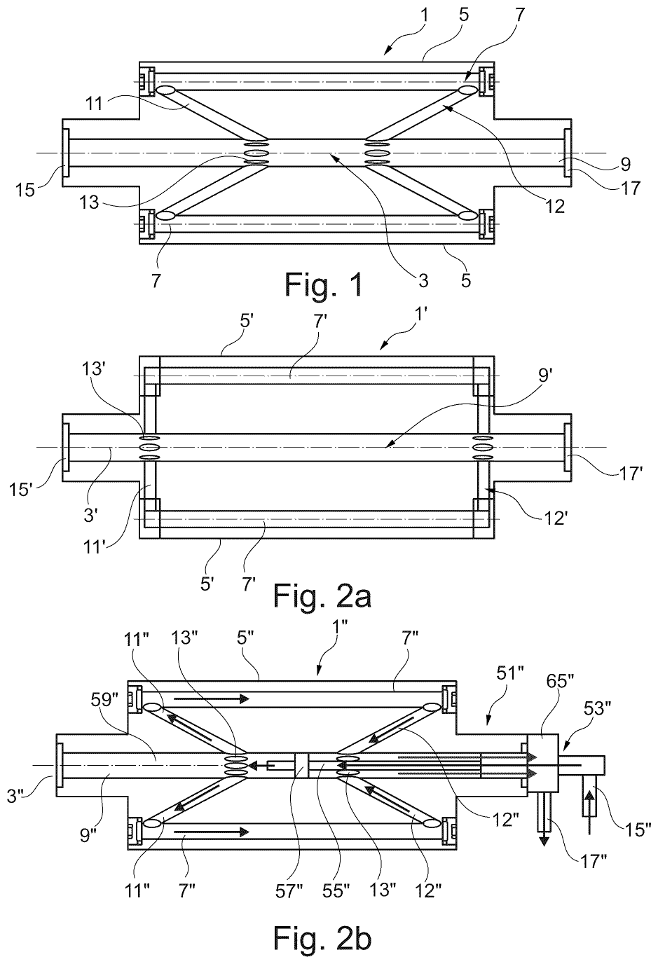

FIG. 1 shows a schematic cross-sectional view of an embodiment of a fluid-heated roller;

FIG. 2a shows a schematic cross-sectional view of a further embodiment of a fluid-heated roller;

FIG. 2b shows a schematic cross-sectional view of an alternative embodiment of a fluid-heated roller;

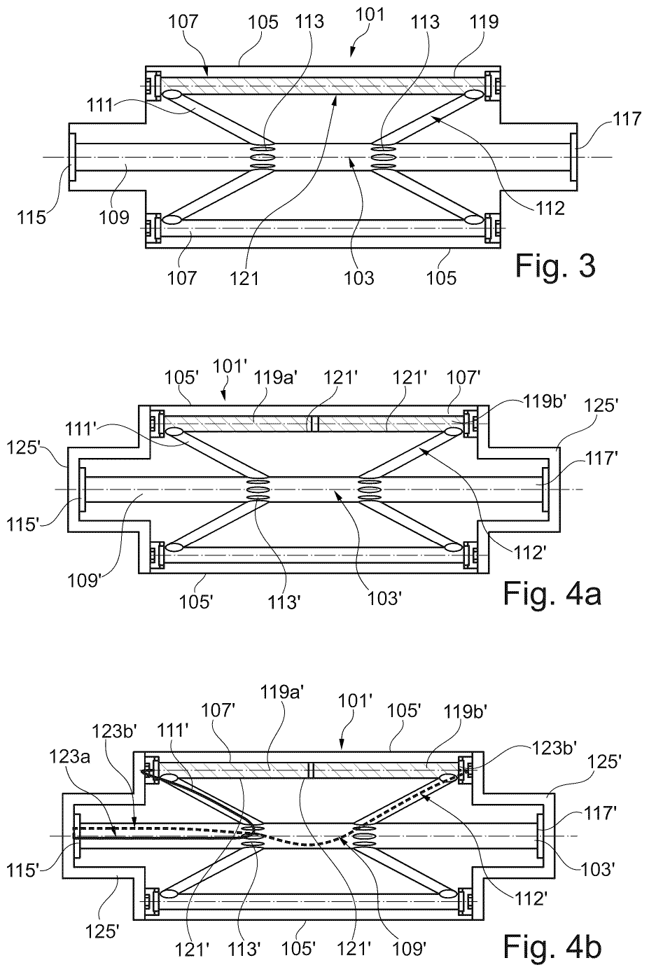

FIG. 3 shows a schematic cross-sectional view of a first embodiment of a roller according to the invention based on the roller according to FIG. 1 using a filler material as a heat conducting element;

FIG. 4a shows a schematic cross-sectional view of a second embodiment of a roller according to the invention based on the roller according to FIG. 1 using a filler material as a heat conducting element;

FIG. 4b shows a schematic cross-sectional view of the roller of FIG. 4a with partially shown wiring;

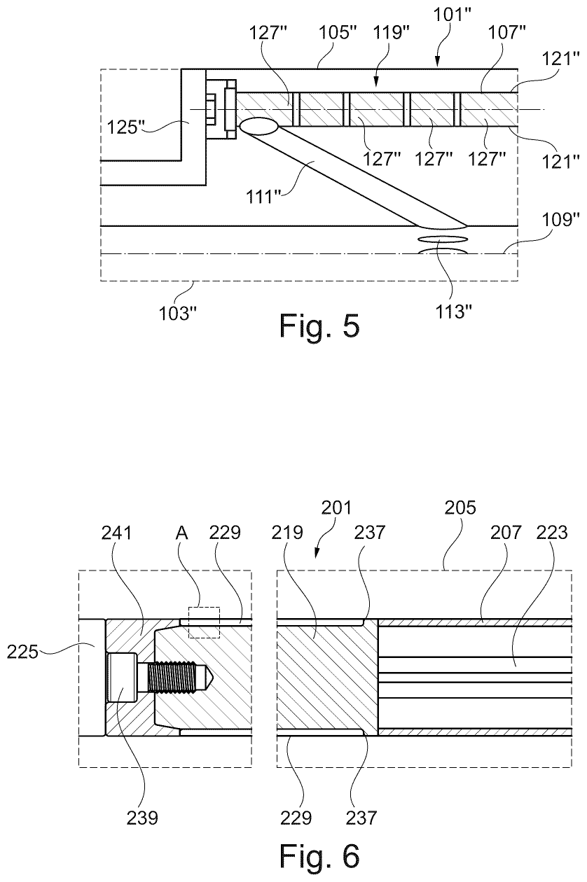

FIG. 5 shows a schematic cross-sectional view of a third embodiment of a roller according to the invention based on the roller according to FIG. 1 using a filler material as a heat conducting element;

FIG. 6 shows a schematic cross-sectional view of a third embodiment of a roller according to the invention based on the roller according to FIG. 1 using a clamping element as a heat conducting element;

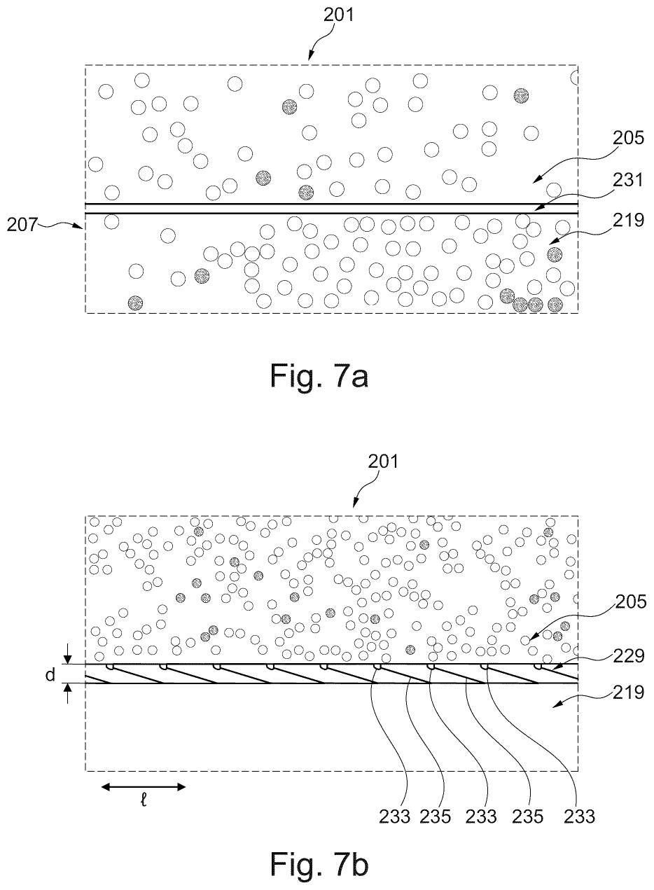

FIG. 7a a detailed view of section A of the roller of FIG. 6 with the clamping element omitted; and

FIG. 7b a detailed view of section A of the roller of FIG. 6 showing the clamping element.

FIG. 1 shows a first embodiment of a roller 1. The roller 1 is rotatable around an axis of rotation 3 and comprises a lateral surface 5. Channels 7 are arranged in the area of the lateral surface 5. A fluid, such as oil, can flow through these channels 7 in order to heat the lateral surface 5. Multiple channels 7, for example 18 channels, are distributed around the circumference of the roller around the axis of rotation 3, wherein only two channels 7 are shown in FIG. 1.

The channels 7 are fed with the fluid via a central channel 9, wherein a connection of the channels 7 to the central channel 9 is provided via inlet channels 11 and outlet channels 12. The inlet channels 11 open into the central channel 9 via connecting openings 13. As indicated in FIG. 1, multiple connecting openings 13 are distributed over the circumference of the central channel 9 around the axis of rotation 3, each of which opens into inlet channels (not shown), via which fluid for heating the lateral surface 5 can be fed to the previously described further channels, which are distributed over the circumference of the roller 1 in addition to the channels 7.

The fluid is fed to the roller 1 via an inlet 15 arranged in the area of the axis of rotation 3 and discharged via an outlet 17 also arranged in the area of the axis of rotation 3. After passing through the central channel 9, the inlet channels 11, the channels 7, and the outlet channels 12, the fluid is discharged via the outlet 17 and heated by a heating device (not shown) and then fed back to the inlet 15.

FIG. 2a shows a further embodiment of a roller 1′. The elements of the roller 1′ which correspond to those of the roller 1 bear the same reference numerals, but are provided with a single apostrophe.

The roller 1′ differs from the roller 1 essentially in that the course and position of the inlet channels 11′ and outlet channels 12′ as well as the connecting openings 13′ differ from that in the roller 1. While in the roller 1 the inlet and outlet channels 11, 12 extend inclined at an acute angle relative to the axis of rotation 3, in particular diagonally, the inlet and outlet channels 11′, 12′ extend perpendicular to the axis of rotation 3′ radially outward, in particular vertically.

Furthermore, FIG. 2b shows a further alternative embodiment of a fluid-heated roller 1″. The elements of the roller 1″ which correspond to those of the roller 1 bear the same reference numerals, but are provided with a double apostrophe.

In comparison to the roller 1, in the roller 1″ the inlet 15″ and the outlet 17″ are not arranged on opposite sides of the roller 1″ or axis of rotation 3″, but on one side of the roller 1″ or axis of rotation 3″. The fluid is therefore supplied and discharged via one side. On the other side, more space can then be provided for a drive of the roller 1″. In principle, one can therefore speak of a drive side on the one hand and a heating side, which in particular does not fulfill a drive function but only a mounting function.

For this purpose, a bearing 51″ has the fluid guidance system 53″ described below. The fluid guidance system 53″ comprises a central line 55″ arranged in the central channel 9″. Furthermore, a seal element 57″ is arranged in the central channel 9″. The central line 55″ extends through the seal element 57″. This allows heating fluid fed via the inlet 15″ to flow along the arrows in FIG. 2b, in particular to flow into an area 59″ of the central channel.

The area 59″ is thus closed on one side by the seal element 57″ and on the opposite side the area 59″ or the central channel 9″ is closed by a closure element 61″. The closure element 61″ is arranged in particular on the drive side of the roller 1″. From the area 59″ the heating fluid flows through the connecting openings 13′ opened in the area 59″ into the inlet channels 11″ and from there into the channels 7″.

After passing through the channels 7″, the fluid flows out of the channels 7″ through the outlet channels 12″ after at least partially transferring the heating power to the roller 1″. It then flows into an area 63″ surrounding the central line 55″. This area 63″ is separated or sealed from the area 59″ by the seal element 57″.

The fluid then flows from the drain channels 12″, through the connecting openings opening into the area 59″ into the area 59″ and from there via a bearing element 65″ of the bearing 51″ into the outlet 17″.

Such fluid-heated rollers 1, 1′, 1″ have generally proven themselves, but have the disadvantage that the maximum temperature of the lateral surface is limited due to the maximum temperature of the fluid.

It is therefore desirable to be able to convert the rollers 1, l′ to heating by an electric heating element, in particular in order to be able to achieve higher temperatures of the lateral surface 5, 5′.

The invention enables such a conversion, which will now be explained with reference to FIGS. 3 to 7b. The conversion will be explained on the basis of the roller 1, wherein the conversion of roller l′ can be carried out analogously.

FIG. 3 shows a converted roller 101. The elements of the roller 101 which correspond to those of the roller 1 bear the same reference numerals, but increased by 100.

As can be seen from FIG. 3, at least one heating element 119 is arranged in the channels 107 for the conversion. In FIG. 3, this is shown only for one channel 107, wherein further heating elements are arranged in the other, in particular all, channels 107.

The heating elements 119 have an outer diameter that is smaller than the inner diameter of the channels 107. In particular, the channels 107 are subject to large tolerances, since high requirements are not placed on the uniformity of the inner diameter of the channels 107 for fluid heating. Thus, the production of a press fit between heating element 113 and channel 107 is not possible without extensive adaptation of the channel 107. However, such an adaptation of the channel 107, in particular the compensation of the tolerances, would entail extensive post-processing of the roller, in particular to avoid imbalances of the roller and to ensure a uniform, vibration-free rotation of the roller 101. In order to nevertheless ensure efficient heat transfer from the heating elements 119 to the lateral surface 105, the invention proposes that the distance between the heating element 119 and the channel 107 is compensated by a heat conducting element. In the embodiment shown in FIG. 3, the heat conducting element comprises a powdered filler material 121. The filler material has a comparatively high graphite content, in particular more than 70%. This ensures that a high thermal conductivity is provided and, at the same time, the powder form ensures that any intermediate spaces between the heating element 119 and the inner wall of the channel 107 are completely filled when the filler material 121 is filled. This avoids local thermal insulation between heating element 119 and the inner wall of channel 107 due to air, which could otherwise result in local overloading of the heating element due to insufficient heat dissipation from the heating element 119. Such an overload can result in defects in the heating element, in particular if temperatures of up to 750° C. are to be generated on the lateral surface 105.

In the roller 101 shown in FIG. 3, a single heating element is inserted into the respective channel 107.

FIGS. 4a and 4b show a further embodiment of a roller 101′. The elements of the roller 101′ which correspond to those of the roller 101 bear the same reference numerals, but are provided with a single apostrophe. In contrast to the roller 101, multiple heating elements 119a′, 119b′ are arranged in a channel 107′ in the roller 101′.

The heating elements 119a′, 119b′ can be actuated and regulated separately so that desired heating profiles can be generated on the jacket surface 105′. It is also possible to equalize or compensate for any fluctuations in the thermal conductivity of the lateral surface 105′.

FIG. 4b shows the wiring of the heating elements 119a′, 119b′. The heating element 119a′ is connected to a cover 125′ in the area of the inlet 115′ via a wiring 123a′ which extends through the inlet channel 111′, a connecting opening 113′, and the central channel 109′. The heating element 119b′ is also connected to the cover 125′ via a wiring 123b′ which extends through the outlet channel 112′, a connecting opening 113′, and the central channel 109′. The contacting of the rotating roller 101′, in particular the wiring 123a′, 123b′, takes place, for example, via slip rings.

The cover 125′ also fulfills still further functions, in particular, in addition to guiding the wiring 123a′, 123b′ and protecting it, fixing the heating elements 119a′, 119b′, for example, against twisting, and thermally insulating the lateral surfaces of the roller 101′. The fixing of the heating elements 119a′, 119b′ can be assisted by the fact that the heating elements 119a′, 119b′ are each preloaded using a spring on a side facing away from the cover 125′ in order to compensate for the thermal expansion of the heating elements 119a′, 119b′ along the axis of rotation 103′. The heating elements 119a′, 119b′ can be connected to the cover 125′ via a direct screw connection to the cover 125′ or an indirect connection via a fixing piece that is screwed to the respective heating element 119a′, 119b′.

It is particularly preferred that during the conversion of the roller 1 into the roller 101 or 101′, a rounding of the edges takes place in the transition between the channels 107, 107′, the inlet and outlet channels 111, 111′, 112, 112′, the connecting openings 113, 113′, and/or the central channel 109, 109′. This prevents damage to the wiring 123a′, 123b′, for example cutting through. Due to the accessibility of the respective channels, this can be done in particular by inserting a rotating deburring tool, such as a pipe deburrer and/or at least one conical milling cutter, into the respective channels, wherein this is due to the diagonal course of the channels 111, 111′, 112, 112′ in the roller 1, 101, and 101′ respectively.

FIG. 5 shows a further embodiment of a roller 101″. The elements of the roller 101″ which correspond to those of the roller 101 or 101′ bear the same reference numerals, but are provided with a double apostrophe. In comparison to the roller 101′, the roller 101″ has a single heating element 119″, but this heating element 119″ has multiple heating zones 127″ in comparison to the heating element 119 of the roller 101. These heating zones can be actuated separately, similar to the heating elements 119a′, 119b′, and thus enable the formation of a heating profile along the longitudinal axis of the roller 101″, in particular along the axis of rotation 103″.

Although in FIGS. 3 to 5 a conversion of a roller according to the structure of the roller 1 of FIG. 1 was explained, a corresponding conversion can also be carried out on rollers according to the configuration of the rollers l′ and/or 1″ of FIGS. 2a and 2b, which have correspondingly different fluid guidance systems.

FIGS. 6 to 7b show an alternative embodiment of a roller 201. The elements which correspond to those of the roller 101 bear the same reference numerals, but increased by 100.

In comparison to the roller 101, the heat conducting element in the roller 201 is implemented by a clamping element in the form of a conical clamping element 229. The conical clamping element 229 can be used alternatively or in addition to the at least partially fluid and/or pourable heat conducting element described in the preceding description, in particular in the form of the filler material 121, 121′, 121″. For the sake of simplicity, the filler material is omitted in FIGS. 6 to 7b, but can be used in addition to the conical clamping element 229 or can be omitted entirely. In addition to the function of the heat conducting element, the conical clamping element 229 also fulfills the function of fixing the heating element 219 along a longitudinal direction or direction of rotation of the roller 201.

The conical clamping element 229 comprises a metallic material having good thermal conductivity properties. The direct contact of the conical clamping element with the surface of the heating element 219 on the one hand and the inner wall of the channel 207 on the other hand ensures that the best possible heat dissipation from the heating element 219 into the lateral surface 205 is achieved.

FIG. 7a shows a section A of the roller 201 in FIG. 6 without the conical clamping element 229. As can be seen, there is an air gap 231 between the heating element 219 and the lateral surface 205. This results in thermal insulation between heating element 219 and lateral surface 205, or at least worsening of the heat transfer from the heating element 219 to the lateral surface 205.

FIG. 7b shows the same section A of the roller 201 in FIG. 6 with the conical clamping element 229. As can be seen from FIG. 7b, the conical clamping element 229 creates a direct bridge between the heating element 219 and the lateral surface 205 via the inner wall of the channel 207. This ensures the best possible heat transfer.

As can also be seen from FIG. 7b, the conical clamping element comprises multiple elements 233 which, when compressed along the longitudinal direction 1, run onto one another via mutually inclined run-up surfaces 235 in such a way that a thickness d of the conical clamping element can be changed, in particular increased.

This compression of the conical clamping element 229 can, as shown in FIG. 6, take place in that the conical clamping element 229 is supported on the one hand on a step 237 of the heating element 219 and on the other hand on a fixing element 241 connected to the heating element 219 by means of a screw 239. The distance between step 237 and fixing element 241 and thus the compression of the conical clamping element 229 can be changed by the screw connection.

Any remaining free spaces between the conical clamping element 229 on the one hand and the heating element 219 or wall 207 on the other hand can optionally be filled by the at least partially fluid and/or pourable heat conducting element, in particular the filler material, and the heat conduction can thus be optimized. However, the use of the at least partially fluid and/or pourable heat conducting element, in particular the filler material, is optional and can also be omitted.

The features described and disclosed in the above description, in the claims, and in the figures can be essential for the invention in its various embodiments both individually and in any combination.

### LIST OF REFERENCE NUMERALS

1, 1′, 1″ roller
3, 3′, 3″ axis of rotation
5,5′, 5″ lateral surface
7,7′, 7″ channel
9,9′, 9″ central channel
11, 11′, 11″ inlet channel
12, 12′, 12″ outlet channel
13, 13′, 13″ connecting opening
15, 15′, 15″ inlet
17, 17′, 17″ outlet
51″ bearing
53″ fluid guidance system
55″ central line
57″ seal element
59″ area
61″ closure element
63″ area
101, 101′, 101″ roller
103, 103′, 103″ axis of rotation
105, 105, 105″ lateral surface
107, 107′, 107″ channel
109, 109′, 109″ central channel
111, 111′, 111″ inlet channel
112, 112′ outlet channel
113, 113′, 113″ connecting opening
115, 115′ inlet
117, 117′ outlet
119, 119″ heating element
119a′, 119b′ heating element
121, 121′, 121″ filler material
123a′, 123b′ wiring
125′, 125″ cover
127″ heating zone
201 roller
205 lateral surface
207 channel
219 heating element
223 wiring
225 cover
229 conical clamping element
231 air gap
233 clement
235 run-on surfaces
237 step
239 screw
241 fixing clement
A section
thickness
I longitudinal direction

1. Roller for a rolling mill, embossing unit, and/or printing unit, comprising at least one heating device for heating the lateral surface of the roller, wherein the heating device comprises at least one channel arranged within the roller, characterized in that
at least one electrical heating element is arranged within the channel, and at least one, at least partially fluid and/or pourable, heat conducting element is arranged in at least one intermediate space between an outer surface of the heating element and an inner wall of the channel.

2. Roller according to claim 1, characterized in that
the channel is designed as a fluid channel, wherein the fluid channel is suitable for having at least one heating fluid flow through it, in particular before the heating element is arranged in the fluid channel or after the heating element is removed from the fluid channel.

3. Roller according to claim 2, characterized in that
the heating fluid comprises oil, water, and/or a glycol-containing liquid.

4. Roller according to claim 1, characterized in that
the heat conducting element, furthermore, comprises at least one clamping element, in particular a conical clamping element, which at least in some areas can be brought into contact, in particular mechanical and/or heat conducting contact, with the lateral surface of the heating element and the inner surface of the channel and/or forms the heat conducting element.

5. Roller according to claim 4, characterized in that
a thickness of the clamping element is changeable and/or adjustable along a normal direction of the surface of the heating element and/or a normal direction of the inner surface of the channel.

6. Roller according to claim 4, characterized in that
the clamping element comprises at least in some areas at least one metallic material, optionally aluminum, copper, magnesium, brass, bronze, silver, gold, and/or tungsten.

7. Roller according to claim 1, characterized in that
the, at least partially fluid and/or pourable, heat-conducting element comprises at least one filler material, optionally containing graphite, arranged at least partially in the intermediate space.

8. Roller according to claim 7, characterized in that
the graphite content in the filler material is more than 40%, preferably more than 50%, more preferably more than 60%, still more preferably more than 70%, still more preferably more than 80%, and most preferably more than 90%.

9. Roller according to claim 7, characterized in that
the filler material is powdery at least in some areas, pasty at least in some areas, and/or highly viscous at least in some areas.

10. Roller according to claim 1, characterized in that
the heating element has at least two, preferably a plurality of heating zones, wherein the heating zones are arranged along a longitudinal direction of the channel and/or heating element and/or the heating zones are arranged in a circular direction of the channel and/or the heating element and/or the heating zones have different first characteristics, in particular different heating outputs and/or different heating times.

11. Roller according to claim 1, characterized in that
at least two, preferably a plurality of heating elements are present, wherein the heating elements have different second characteristics, in particular different heating outputs and/or different heating times.

12. Roller according to claim 1, characterized by
at least one sensor, in particular a temperature sensor, which is inserted at least in some areas into the channel and/or is operatively connected to the channel.

13. Roller according to claim 1, characterized in that
the roller is usable in a printing unit, embossing unit, and/or rolling mill for producing elements of an electrical storage device, such as a battery, an accumulator, a capacitor, an electrolyzer, and/or a fuel cell.

14. Printing unit, embossing unit, and/or rolling mill, in particular for producing elements of an electrical storage device, such as a battery, an accumulator, a capacitor, an electrolyzer, and/or a fuel cell, comprising at least one roller according to claim 1.

15. Method for converting a heating device of a roller, comprising
providing a roller having at least one fluid channel suitable for at least one heating fluid to flow through it,
arranging at least one electrical heating element in the fluid channel, and
arranging at least one, preferably at least partially fluid and/or pourable, heat conducting element in at least one intermediate space between an outer surface of the heating element and an inner wall of the channel.

16. Method according to claim 15, characterized in that
at least one wiring of the heating element is arranged in at least one central channel, at least one inlet channel, in particular of the fluid channel, at least one outlet channel, in particular of the fluid channel, and/or at least one connecting opening, in particular of the central channel, the inlet channel, and/or the outlet channel.

17. Method according to claim 16, characterized in that
the arrangement of the wiring comprises the prior smoothing and/or rounding of acute-angled edges present in the fluid channel, the outlet channel, the connecting opening, the central channel, and/or the inlet channel, optionally using at least one mechanical deburrer, optionally comprising at least one pipe deburrer and/or at least one conical milling cutter.
